(19) United States
(12) Patent Application Publication
(10) Pub. No.: US 2017/0154305 A1
(43) Pub. Date: Jun. 1, 2017

(54) SHARED MATCHMAKING MANAGEMENT METHOD TO ENHANCE SUPPLY AND MARKETING EFFICIENCY

(71) Applicant: SPRINDER TECHNOLOGY INC., TAIPEI CITY (TW)

(72) Inventor: SHENG-YEN CHEN, TAIPEI CITY (TW)

(21) Appl. No.: 14/953,039

(22) Filed: Nov. 27, 2015

(51) Int. Cl. G06Q 10/10

(52) U.S. Cl. CPC G06Q 10/103

(57) ABSTRACT

A shared matchmaking management method to enhance supply and marketing efficiency is disclosed, including log in: constructing a network platform that includes a supplier database, a human resource database, an industry database, and an end procurement database, to provide storage respectively for suppliers and product data thereof, sales personnel data, industry procurement department data, and industry market messages; matchmaking: based on a target market of a supplier, the network platform performing matchmaking with at least a sales personnel; execution: disposing a mobile communication device installed with a flow application, the mobile communication device provided to the sales personnel, the flow application connected to the network platform so that the sales personnel being informed of up-to-date industry information, the sales personnel being assigned by the network platform to at least a corporate procurement department for marketing and storing an order from the corporate procurement department to the end procurement database.

### TECHNICAL FIELD OF THE INVENTION

The present invention relates generally to a matchmaking and management method for suppliers and sales personnel, and more particularly to a multi-party management method using a network platform to match suppliers and sales personnel, to allow the sales personnel to market to the procurement department, process orders, and process cash flows of suppliers and the sellers.

### DESCRIPTION OF THE PRIOR ART

The concept of human resource management emerged in 1990s when many companies started to emphasize the importance of recruiting, developing and retaining talents to drive the growth of the company. At present, human resource management is defined in various ways. Morton, in a 2006 paper, defined the eight categories of the human resource management activities: recruiting, retaining, growing, leadership development, performance management, employee feedback/measurement, human resource planning and culture. In 2005, Fitz-enz considered the human resource management includes six human resource services: hiring and placement, leadership development, succession, performance management, training and education, and retaining. In 2005, Farley also proposed that the human resource management is a process to encourage the employees to exert their values, and the core issue at the heart of human resource management becomes: attract, hire, cultivate and retain talents.

Human resource management is a series of activities of planning, organizing, coordination and controlling performed on the internal and external factors affecting the performance of the talents. A broader definition of human resource management includes the prediction, planning, selection, hiring, evaluation, incentives, and retaining of talents; while a narrower definition includes only evaluation, incentives and retaining of human resource. The objects of the human resource management are to create good external conditions, adjust the internal factors so as to maximize the performance and the potential of the human resource. Human resource management is an important and necessary factor on human resource efficiency and performance.

However, the known human resource management technology is insufficient. As the management is only conducted within a company, is unable to maximize the capability of the talents, talents are difficult to retain, leading to future loss of the company.

The key of human resource management is to create an environment for human development and growth. It should be considered as a high level activity. However, the known management technique is still based on human-to-human paradigm, which often fails to place people at their most suitable environment. Therefore, it is imperative to improve the known human resource management system.

An object of the present invention is to provide a human resource management system, wherein every department head requesting human resource is able to log on and search and evaluate the requested human resource.

In view of the above, the present invention aims to provide a solution that helps eliminates and alleviate the above drawbacks.

### SUMMARY OF THE INVENTION

In view of the above drawbacks, the present invention provides a shared matchmaking management method to enhance supply and marketing efficiency, which comprises log in: constructing a network platform, including a supplier database, a human resource database, an industry database, and an end procurement database, to provide storage respectively for suppliers and product data thereof, sales personnel data, industry procurement department data, and industry market messages; matchmaking: based on a target market of a supplier, the network platform performing matchmaking with at least a sales personnel, and dispatching the sales personnel from the human resource database; execution: disposing a mobile communication device installed with a flow application, the mobile communication device provided to the sales personnel, the flow application connected to the network platform so that the sales personnel being informed of up-to-date industry information, the sales personnel being assigned by the network platform to at least a corporate procurement department for marketing and using the flow application to report progress, and storing an order from the corporate procurement department to the end procurement database.

The objects of the shared matchmaking management method to enhance supply and marketing efficiency of the present invention are:

(1) Using a network platform to attract suppliers and sales personnel to match making so that the suppliers can rapidly improve product sales and market share and the sales personnel can achieve high incentive rewards.

(2) The sales personnel can cooperate with a plurality of suppliers, and tap into the market through the industry experience of the sales personnel to maximize the efficiency.

(3) The network platform can integrate the cash flow and the product flow of the suppliers and the corporate procurement departments, and then reward the sales personnel according to the order so as to attract and retain human resources.

(4) Using a flow application to monitor in real-time the order from the corporate procurement department and usage to improve the information propagation efficiency of the suppliers and the sales personnel.

(5) Attracting talents from various industries, and providing sales and marketing solution, the network platform can become an effective channel.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows the steps of the present invention.

FIG. 2 is a schematic view showing the structure of a network platform according to the present invention.

FIG. 3 shows the steps of matchmaking according to the present invention.

FIG. 4 is a schematic view showing the network platform and flow application transportation according to the present invention.

FIG. 5 is a schematic view illustrating a use of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

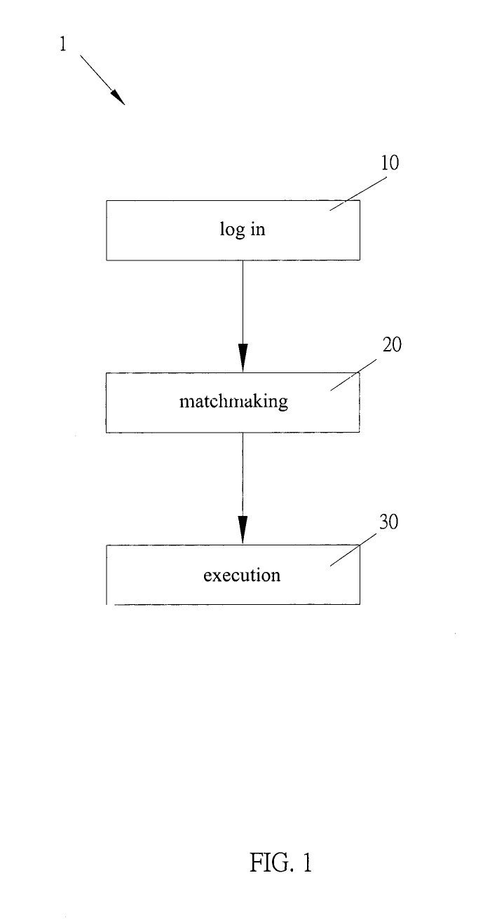

Referring to FIG. 1, a shared matchmaking management method to enhance supply and marketing efficiency according to the present invention comprises the following steps: log in (Step 10), matchmaking (Step 20), and execution (Step 30). Each of the steps will be described in details as follows:

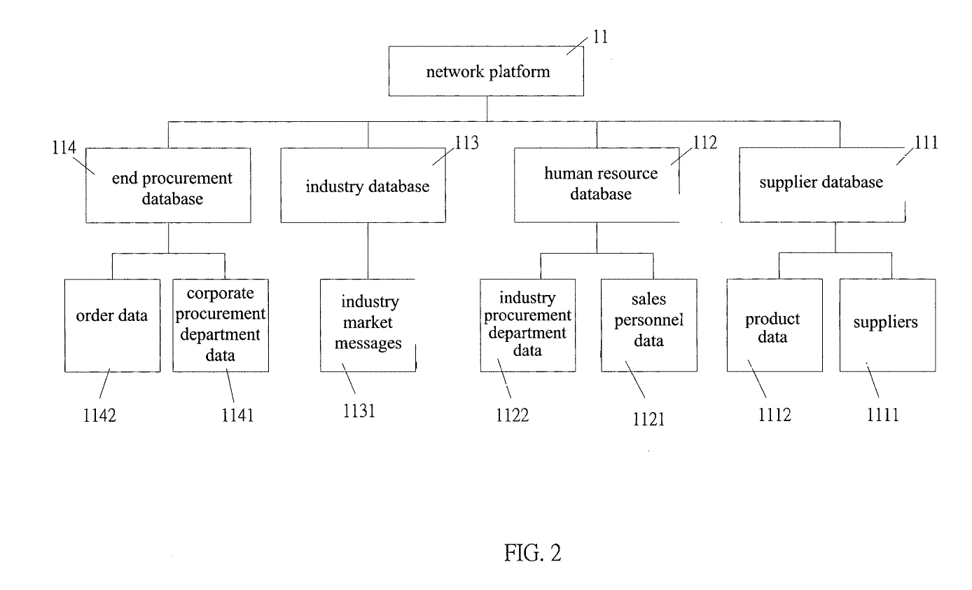

Referring to FIG. 2, log in 10 comprises: constructing a network platform 11, which comprises a supplier database 111, a human resource database 112, an industry database 113, and an end procurement database 114, wherein the supplier database storing a plurality of suppliers 1111 and product data 1112 thereof.

The human resource database 112 stores sales personnel data 1121 and industry procurement department data 1122.

The suppliers 1111 and the sales personnel are involved in a membership system and must become members to be allowed to log in the network platform 11.

The sales personnel, after filing an application for membership, will be first accepted as an offline personnel of the network platform 11 and the offline personnel stays in a standby, ready state and will become the sales personnel after being matched to the market target.

The industry database 113 stores a plurality of industry market messages 1131, including revenue, incentive information, new product alert and industry trends.

The end procurement database 114 stores a plurality of corporate procurement department data 1141 and order data 1142.

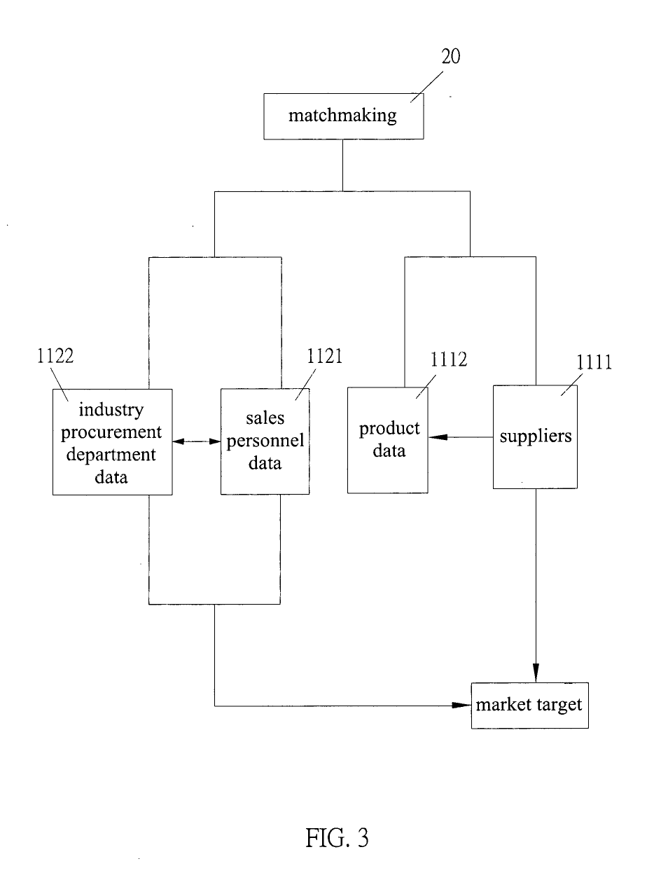

Referring to FIG. 3, matchmaking 20: Based on a target market of a supplier 1111, the network platform 11 performs matchmaking with at least a sales personnel to the supplier 1111. The industry procurement department data 1122 of the sales personnel matches the target market of the supplier 1111.

In other words, the matchmaking between the target market of the supplier 1111 and the sales personnel is performed by the network platform 11 through comparison and analysis so that the corporate procurement department 40 corresponds to the industry procurement department data 1122 of the sales personnel.

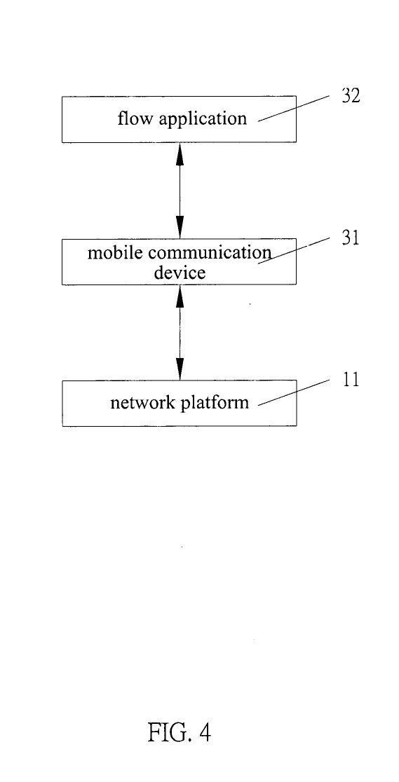

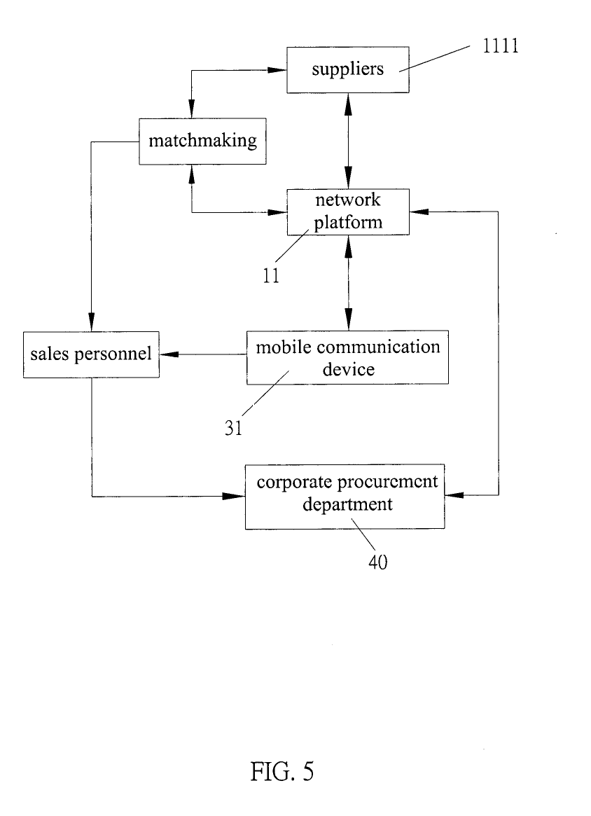

Referring to FIGS. 4 and 5, execution 30: Disposing a mobile communication device 32 installed with a flow application 31, the mobile communication device 32 is provided to the sales personnel and the flow application 31 is connected to the network platform 11 so that the sales personnel is informed of up-to-date industry messages 1131. The sales personnel is deployed by the network platform 11 to at least a corporate procurement department 40 for marketing. The corporate procurement department corresponds to the target market. The sales personnel store an order from the corporate procurement department 40 to the end procurement database 114 to form an order data 1142.

In other words, the sales personnel own experiences of contacting and marketing to at least a corporate procurement department 40. Therefore, it is easier for the sales personnel to market the products from the supplier 1111 to the corporate procurement department 40, so as to improve the order efficiency and market share of the supplier 1111.

In addition, by constructing the order from the corporate procurement department 40 as an order data 1142, both the supplier 1111 and the sales personnel can view the up-to-date condition of the corporate procurement department 40 for ongoing marketing and monitoring. Moreover, after the order data 1142 is constructed, the corporate procurement department 40 can also lug in to the network platform 11 to inquire the progress of the order data, without contacting the sales personnel or additional document exchange, resulting in efficiency improvement.

After both the sales personnel and the corporate procurement department 40 confirming the sales, the network platform 11 pays the fee to the supplier 1111, and the corporate procurement department 40 pays the network platform 11. Also, the network platform 11 pays a predefined percentage of the fee to the sales personnel.

Moreover, when the supplier 111 runs out of inventory or does not carry a product requested by the corporate procurement department 40, the sales personnel can file a request through the network platform 11 or the flow application 31. Then, the network platform searches another supplier 1111 to supply the request product by the corporate procurement department 40.

In other words, the sales personnel, through flow application 31 or logging in network platform 11, checks the product data 1112 of the supplier database 111 to find potential corporate procurement department 40.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A shared matchmaking management method to enhance supply and marketing efficiency, comprising the following steps:
log-in: constructing a network platform that comprises a supplier database, a human resource database, an industry database, and an end procurement database, wherein the supplier database stores a plurality of suppliers and product data thereof; the human resource database stores at least a sales personnel data, and industry procurement department data thereof; the industry database stores a plurality of industry market messages; and the end procurement database stores a plurality of corporate procurement department data and a plurality of order data;
matchmaking: based on a target market of a supplier, the network platform performing matchmaking with at least a sales personnel, wherein the industry procurement department data of the sales personnel matches the target market of the supplier; and
execution: disposing a mobile communication device installed with a flow application, the mobile communication device provided to the sales personnel, the flow application connected to the network platform so that the sales personnel is informed of up-to-date industry information, the sales personnel being assigned by the network platform to at least a corporate procurement department for marketing, the corporate procurement department being corresponding to the target market, and the sales personnel storing an order from the corporate procurement department to the end procurement database to form an order data.

2. The shared matchmaking management method according to claim 1, wherein the network platform is provided to at least a supplier and at least a sales personnel to apply for membership and log in to the network platform; the sales personnel becomes an offline personnel of the network platform when obtaining membership; the offline personnel stays in a ready state, and becomes the sales personnel after matched to the target market; when the order data from the corporate procurement department is stored in the end procurement database, the corporate procurement department logs in to the network platform to inquire the order data.

3. The shared matchmaking management method according to claim 2, wherein after both the sales personnel and the corporate procurement department confirms the sales of the order data, the network platform pays the fee of the sales to the supplier, and the corporate procurement department pays the network platform.

4. The shared matchmaking management method according to claim 1, wherein the network platform pays a predefined percentage of the fee of the sales to the sales personnel.

5. The shared matchmaking management method according to claim 2, wherein the network platform pays a predefined percentage of the fee of the sales to the sales personnel.

6. The shared matchmaking management method according to claim 4, wherein the network platform pays a predefined percentage of the fee of the sales to the sales personnel.

7. The shared matchmaking management method according to claim 1, wherein the plurality of industry messages comprises revenue, incentive information, new product alert and industry trends.

8. A shared matchmaking management method to enhance supply and marketing efficiency, comprising the following steps:
log-in: constructing a network platform that comprises a supplier database, a human resource database, an industry database, and an end procurement database, wherein the supplier database stores a plurality of suppliers and product data thereof; the human resource database stores at least a sales personnel data, and industry procurement department data thereof; the industry database stores a plurality of industry market messages; and the end procurement database stores a plurality of corporate procurement department data and a plurality of order data;
matchmaking: based on a target market of a supplier, the network platform performing matchmaking with at least a sales personnel, wherein the industry procurement department data of the sales personnel matches the target market of the supplier; and
execution: disposing a mobile communication device installed with a flow application, the mobile communication device provided to the sales personnel, the flow application connected to the network platform so that the sales personnel is informed of up-to-date industry information, the sales personnel being assigned by the network platform to at least a corporate procurement department for marketing, the corporate procurement department being corresponding to the target market, and the sales personnel storing an order from the corporate procurement department to the end procurement database to form an order data, wherein the sales personnel can, through flow application or logging in network platform, check the product data in the supplier database to find potential corporate procurement departments.
